(19) United States
(12) Patent Application Publication
(10) Pub. No.: US 2008/0139411 A1
(43) Pub. Date: Jun. 12, 2008

(54) Methods of treating subterranean formations using hydrophobically modified polymers and compositions of the same

(76) Inventors: Phillip C. Harris, Duncan, OK (US); Stanley J. Heath, Duncan, OK (US); Gary P. Funkhouser, Duncan, OK (US)

Correspondence Address: ROBERT A. KENT, P.O. BOX 1431, DUNCAN, OK, 73536, US

(21) Appl. No.: 11/635,980

(22) Filed: Dec. 7, 2006

(51) Int. Cl. C09K 8/00

(52) U.S. Cl. 507/215

(57) ABSTRACT

Among the many embodiments provided by the invention, in one embodiment, a method is presented that comprises: providing a treating fluid comprising water, a charged polymer in an amount in the range of from about 2000 to about 20000 ppm, and a surfactant having a charge that is opposite to that of the charged polymer, the surfactant being capable of forming a micellar bond between a hydrophobic group on the polymer and a hydrophobic group on the same or an adjacent polymer molecule to form a crosslink; and placing the treating fluid into a well bore. Another embodiment provides a method that comprises: providing a viscosified treating fluid comprising: water; a charged polymer in an amount in the range of from about 2000 to about 20000 ppm; a surfactant having a charge that is opposite to that of the charged polymer; and at least one micellar association of between the surfactant with the charged polymer; and placing the viscosified treating fluid into a well bore.

### BACKGROUND

The present invention relates to improved methods for fracturing a subterranean formation, and more particularly, to hydrophobically modified polymer compositions for use in treating subterranean formations.

Hydraulic fracturing operations are often carried out on oil and gas wells to increase the flow of oil and natural gas therefrom. For example, the fracturing fluid creates fractures in the formation and transports and deposits proppants into the fractures. The proppants hold the fractures open after the fracturing fluid flows back into the well. To adequately propagate fractures in subterranean formations, the fracturing fluid should exhibit minimal fluid loss into the formation and should have sufficient viscosity to carry large volumes of proppant into the cracks in the formation formed during fracturing. The fracturing fluid, however, should also readily flow back into the well after the fracturing operation is complete, without leaving residues that impair permeability and conductivity of the formation.

In order to increase the viscosity of fracturing fluids, hydratable high molecular weight polymers such as polysaccharides, polyacrylamides and polyacrylamide copolymers are often added to the fluids. The viscosity can be further increased by adding crosslinking compounds to the fluids. The term “crosslink” is used herein to refer to “an attachment of two polymer molecules by bridges, composed of either an element, a group, or a compound that joins certain atoms of the chains by association.” Conventional crosslinking agents such as polyvalent metal ions or borate ions form chemical bonds between the viscosifier polymer molecules which raise the viscosity of the solution. In order to allow the crosslinked fluid to flow back out of the formation and into the well, a breaker is sometimes added to the fracturing fluid to degrade the molecular weight and thereby reduce the viscosity of the fracturing fluid.

Viscoelastic surfactants have also been added to fracturing fluids to increase the viscosity thereof. For example, gels can be formed by the association of hydrophobic portions of surfactants to form micelles or larger associative structures. The micelles or other associative structures increase the viscosity of the base fluid. As used herein, the term “micelle” is defined as “a colloidal particle composed of aggregates of surfactant molecules.”

During the fracturing operation, the polymers and other compounds used to increase the viscosity of the fracturing fluid desirably form a film over the fracture matrix, referred to as a “filtercake.” The filtercake is thought to prevent excessive fluid leakage into or out of the formation. After the fracturing operation is complete, however, as much of the filtercake as possible should be removed to obtain optimal production. In particular, filtercakes deposited from conventional crosslinked fracturing fluids can be difficult to remove and can significantly interfere with oil and gas production.

Hydrophobically modified polymers (“HMPs”) have been utilized to thicken and raise the viscosity of fracturing fluids. Micellar bonds are formed between hydrophobic groups on the polymers, which result in a three-dimensional associated network that thereby increases the viscosity of the fluids. Surfactants are used to promote the formation of micellar bonds. As used herein, the terms “micellar associations” and “micellar bonds” refer to those associative interactions between hydrophobic groups on HMP molecules.

Unlike conventional crosslinked fracturing fluids, the micellar associations between hydrophobic groups of HMPs are thought to be weaker than covalent chemical bonds, and thus are more easily disruptable. Also, the bonding strength of a micellar association is thought to be less than the bonding strength obtained from the chemical complex formation utilizing polyvalent metal and borate ion conventional crosslinkers. This enhanced reversibility of a micellar association is thought to minimize the likelihood of damage to a reservoir allowing easier removal of the fracturing fluid from the fractured reservoir. By disrupting the miceller bonds, the polymer may revert back to “unassociated” polymer, and consequently, the viscosity of the solution should be substantially decreased. HMP fracturing fluids also leave less residual filtercake than conventional crosslinked fluids, resulting in, among other things, improved post fracture conductivity and formation permeability. Unfortunately, HMPs that may be used in subterranean operations are very limited in number.

### SUMMARY

The present invention relates to improved methods for fracturing a subterranean formation, and more particularly, to hydrophobically modified polymer compositions for use in treating subterranean formations.

An embodiment of the present invention provides a method that comprises: providing a treating fluid comprising water, a charged polymer in an amount in the range of from about 2000 to about 20000 ppm, and a surfactant having a charge that is opposite to that of the charged polymer, the surfactant being capable of forming a micellar bond between a hydrophobic group on the polymer and a hydrophobic group on the same or an adjacent polymer molecule to form a crosslink; and placing the treating fluid into a well bore.

An embodiment of the present invention provides a method that comprises: providing a viscosified treating fluid comprising: water; a charged polymer in an amount in the range of from about 2000 to about 20000 ppm; a surfactant having a charge that is opposite to that of the charged polymer; and at least one micellar association between the surfactant with the charged polymer; and placing the viscosified treating fluid into a well bore.

An embodiment of the present invention provides a viscosified treating fluid that may comprise water; a charged polymer; a surfactant having a charge that is opposite to that of the charged polymer in an amount in the range of from about 2000 to about 20000 ppm of the treating fluid; and at least one micellar association between the surfactant with the charged polymer.

The features and advantages of the present invention will be readily apparent to those skilled in the art. While numerous changes may be made by those skilled in the art, such changes are within the spirit of the invention.

### BRIEF DESCRIPTION OF THE DRAWINGS

These drawings illustrate certain aspects of some of the embodiments of the present invention, and should not be used to limit or define the invention.

FIG. 1 shows an illustration of an embodiment of an ion-pair association between a cationic polymer and an anionic surfactant to form a hydrophobically modified polymer.

FIG. 2 shows an illustration of an embodiment of certain micellar associations between hydrophobic groups on adjacent hydrophobically modified polymers.

FIG. 3 shows an illustration of an embodiment incorporating both micellar associations between hydrophobic groups on adjacent hydrophobically modified polymers and borate crosslinks.

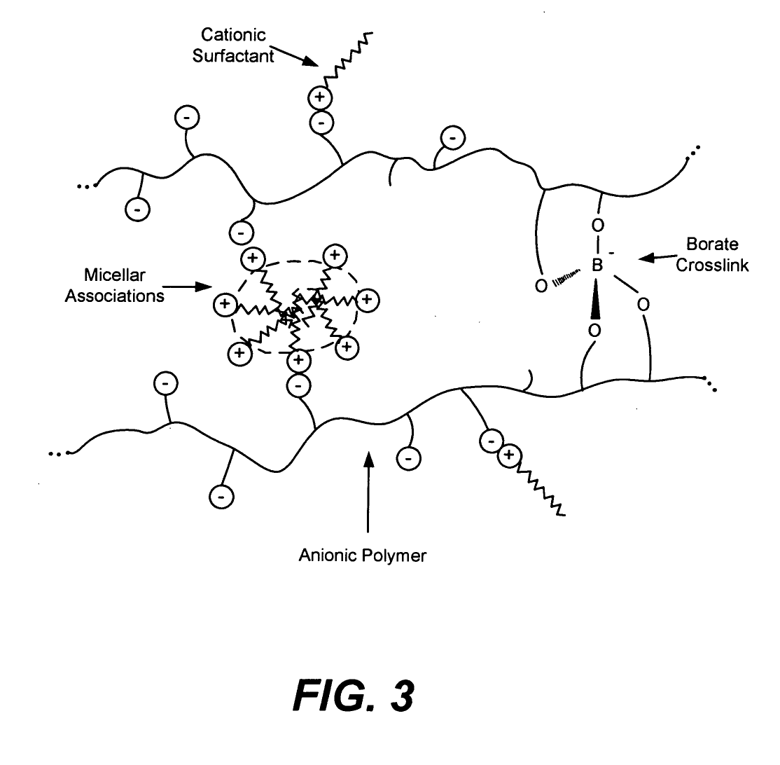

### DESCRIPTION OF PREFERRED EMBODIMENTS

The present invention relates to improved methods for fracturing a subterranean formation, and more particularly, to hydrophobically modified polymer compositions for use in treating subterranean formations. A non-limiting list of subterranean treatments contemplated by the current invention would include: fracturing, gravel packing, drilling and well bore or pipeline cleaning operations. Other uses may be evident to one of ordinary skill in the art with the benefit of this disclosure.

Some methods of this invention for treating a subterranean formation comprise the following steps. A treating fluid is prepared comprising water, a charged polymer, and a surfactant having a charge that is opposite of the charged polymer. The surfactant is capable of forming forming a micellar bond between a hydrophobic group on the polymer and a hydrophobic group on the same or an adjacent polymer molecule to form a crosslink. The resulting viscosified treating fluid may be injected into a wellbore to treat a subterranean formation. As used herein, the term “treatment,” or “treating,” refers to any subterranean operation performed in conjunction with a desired function and/or for a desired purpose. The term “treatment,” or “treating,” does not imply any particular action. As used herein, the term “treating fluid” refers to any fluid that may be used in a subterranean application in conjunction with a desired function and/or for a desired purpose. The term “treating fluid” does not imply any particular action by the fluid or any component thereof. As used herein, the term “viscosified treating fluid,” or “viscosified treating solution composition,” refers to a treating fluid comprising at least one micellar association of the surfactant with the charged polymer, and has at least some viscosity that may be attributed to the micellar association. The term “viscosified treating fluid” does not imply any particular degree of viscosification of the treating fluid.

The treating fluid can be prepared by combining and mixing a known volume or weight of water, polymer and surfactant using mixing procedures known to those skilled in the art. These mixing procedures may be done on-the-fly or in batch.

Hydrophobically modified polymers can be produced by utilizing the charge attraction of cations and anions. This method of producing an HMP is advantageous as compared to prior art methods in that a specialized chemical reactor is not required. Rather than chemically reacting polymers with hydrophobic hydrocarbon units, inter alia, the current invention prepares an HMP by adding a cationic surfactant to an anionic polymer or by adding an anionic surfactant to a cationic polymer.

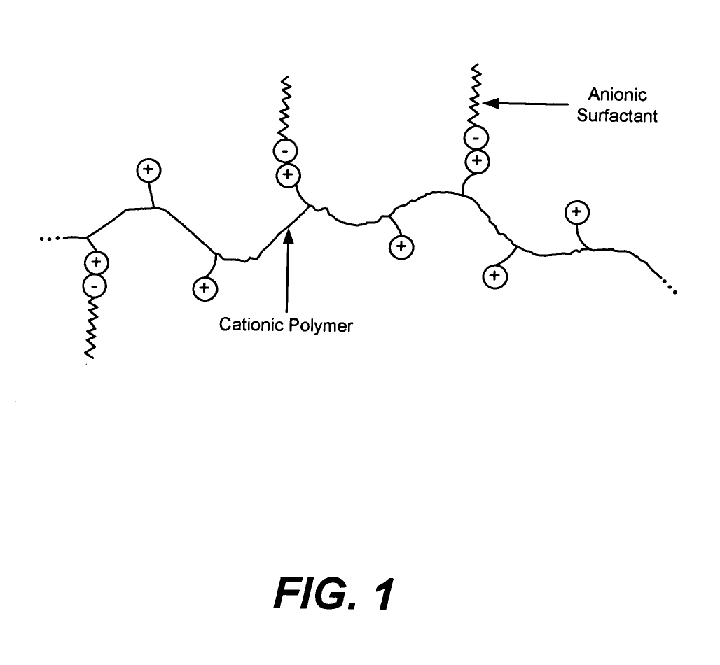

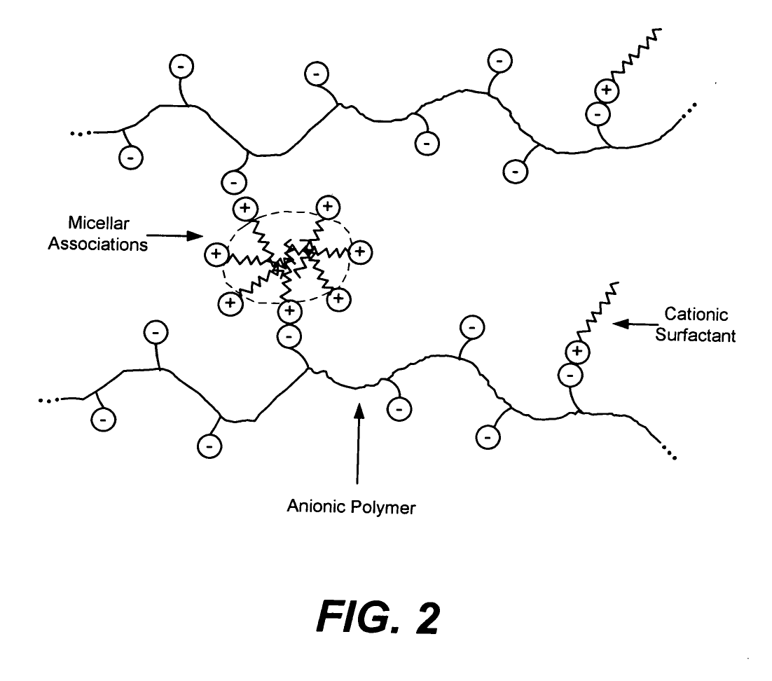

As illustrated in FIG. 1, a resulting ion-pair association between the polymer and the surfactant forms a plurality of hydrophobic groups on or associated with the polymer. Without being limited to any single theory, it is believed that continued addition of surfactant leads to the formation of micellar bonds between hydrophobic groups on a single HMP molecule. These hydrophobic groups are attached to polymers by opposite charge attraction and do not rely on a clustering process to build up a viscous polymer mass. The HMPs also are thought to form crosslinks through micellar association of the surfactant associated with adjacent HMP molecules as illustrated in FIG. 2. Charged micelles may also be present in solution. As the number of crosslinks associated with HMPs in the treating solution composition increases, the viscosity of the composition also should increase to form a viscosified treating solution composition. Furthermore, the micellar associations of the present invention should result in a single-phase system based on water-soluble polymers in an aqueous medium with water-soluble surfactants added. However, due to the nature of the bond joining the hydrophobic groups to the polymer, the resulting crosslinks may be easily disrupted. As used herein, the term “disrupt” refers to the bonds joining the hydrophobic groups to the polymer being broken or separated. The term “disrupt” does not imply any particular degree of breakage or separation. Accordingly, exposure of the treating solution to high shear, excessive temperature, dilution with water, or other suitable conditions may disrupt the micelles, thereby causing the crosslinked HMP to revert to an uncrosslinked polymer solution.

In addition to micellar associations, viscosity of the polymer fluid may be augmented with a suitable borate crosslinker to form a crosslinked fluid. The borate crosslinker may attach at sites other than the hydrophobically modified sites. Full viscosity development results from a combination of HMP crosslinks and borate crosslinks. The inclusion of borate crosslinks may extend the upper temperature range of the treating fluid. Borate crosslinks may be reversible, as are the micellar associations, so that minimal damage results to the formation. Suitable borate crosslinkers may include, for example, alkali metal borates, borax, boric acid, borate esters, and compounds that are capable of releasing borate ions in aqueous solutions.

Preferably, the borate crosslinker may be present in the treatment fluid composition in an amount in the range of from about 0.01% to about 2% by weight thereof, and more preferably in an amount in the range of from about 0.05% to about 1% by weight thereof.

The water utilized in the treating fluids of this invention can be fresh water or salt water depending upon the particular density and the composition required. The term “salt water” is used herein to mean unsaturated salt water including unsaturated brines and sea water. Salts such as potassium chloride, sodium chloride, ammonium chloride, calcium chloride, tetramethylammonium chloride, and other salts known to those skilled in the art may be added to the water to inhibit the swelling of the clays in the subterranean formations so long as the salt does not adversely react with other components of the composition. The water is included in the treating solution composition in an amount ranging from about 95% to about 99.9% by weight thereof, more preferably from about 98% to about 99.5%.

The term “polymer” is defined herein to include natural polymers and their derivatives, synthetic copolymers, terpolymers, and the like. The charged polymer utilized in the compositions of this invention can be either anionic or cationic. Examples of anionic polymers include, but are not limited to, carboxymethyl guar, carboxymethylhydroxypropyl guar, carboxymethylhydroxyethyl cellulose, polyacrylic acid, polyacrylate copolymers, 2-acrylamido-2-methylpropanesulfonic acid and salts, and combinations and mixtures thereof. A preferred anionic polymer is carboxymethylhydroxypropyl guar. Examples of suitable cationic polymers include, but are not limited to, cationic polyacrylamide copolymers, cationic guar, cationic cellulose derivatives, cationic polysaccharide derivatives, choline methacrylate salts, and combinations and mixtures thereof. A preferred cationic polymer is cationic guar. The polymer is generally present in the HMP composition in an amount in the range of from about 2000 ppm to about 20000 ppm (0.2% to 2.0% by weight) of the composition. In some embodiments, the polymer is generally present in the HMP composition in an amount in the range of from about 2000 ppm to about 5000 ppm. In some embodiments, the polymer is generally present in the HMP composition in an amount in the range of from about 2000 ppm to about 3600 ppm.

Surfactants with longer hydrophobic units are generally preferred for their ability to impart higher temperature tolerance and to increase the stability of the micelles. Cationic surfactants which can be used with anionic polymers in the compositions and methods of the present invention include, but are not limited to, trimethylcocoammonium chloride, trimethyltallowammonium chloride, dimethyldicocoammonium chloride, bis(2-hydroxyethyl)tallowamine, bis(2-hydroxyethyl)erucylamine, bis(2-hydroxyethyl)cocoamine, cetylpyridinium chloride, and combinations and mixtures thereof. A preferred cationic surfactant is trimethyltallowammonium chloride.

Suitable anionic surfactants which can be used with cationic polymers in the compositions and methods of the present invention include, but are not limited to, alpha olefin sulfonate, alkylether sulfates, alkyl phosphonates, alkane sulfonates, fatty acid salts, and arylsulfonic acid salts, and combinations and mixtures thereof. A preferred anionic surfactant is alpha olefin sulfonate having a chain length of 14 to 16 carbon atoms.

Generally, the surfactant is present in the treating fluids of the present invention in an amount sufficient to form an ion-pair association with enough of the charged polymer units to produce an increase in viscosity. Preferably, the surfactant is present in the treating fluid in an amount in the range of from about 0.05% to about 1.0% by weight thereof, more preferably from about 0.1% to about 0.6%, and most preferably from about 0.2% to about 0.5%.

Certain viscosity-enhancing agents that are capable of enhancing the formation of micellar bonds between hydrophobic groups on the polymer and hydrophobic groups on the same or adjacent polymer molecules may be used in the present invention. When added to the treating fluid, these agents may further increase the viscosity of the composition. Suitable viscosity-enhancing agents include, but are not limited to, fatty alcohols, ethoxylated fatty alcohols, and amine oxides having hydrophobic chain lengths of 6 to 22 carbon atoms, and mixtures thereof. In some embodiments, the viscosity-enhancing agent may increase the viscosity of the composition above that attainable by the polymer and surfactant alone. The viscosity-enhancing agent may also make the composition less sensitive to phase separation. When included in the treating fluid, the viscosity-enhancing agent is preferably present in an amount ranging from about 0.05% to about 1.0% thereof, and more preferably from about 0.1% to about 0.6%.

The current invention also provides improved methods for fracturing a subterranean formation penetrated by a well bore. In some embodiments, the improved methods utilize a fracturing fluid comprising water, a charged polymer in an amount in the range of from about 2000 to about 20000 ppm of the treating fluid, and a surfactant having a charge that is opposite of the charged polymer. The surfactant is capable of forming micellar bonds between hydrophobic groups on the polymer and hydrophobic groups on the same or adjacent polymer molecules to form crosslinks.

The fracturing fluid may optionally contain a viscosity-enhancing agent and proppant particulates. The fracturing fluid has a viscosity suitable for fracturing the formation according to fracturing methods known to those skilled in the art, and is introduced into the subterranean formation through the well bore under conditions effective to create or enhance at least one fracture in a portion of the formation.

Preferably the fracturing fluid further comprises a proppant. In general, proppants must have sufficient compressive strength to resist crushing, but also be sufficiently non-abrasive and non-angular to preclude cutting and embedding into the formation. Suitable proppant material includes but is not limited to, sand, graded gravel, glass beads, sintered bauxite, resin coated sand ceramics, and intermediate strength ceramics. Preferably, proppants are present in the fracturing fluid in an amount in the range of from about 0.5 lb/gal to about 24 lb/gal thereof, more preferably from about 1 lb/gal to about 12 lb/gal.

The fracturing fluid is thought to exhibit a relatively low friction pressure and shear rehealing, that is, the micellar bonds may be disrupted with shear. At high shear rates in the wellbore, the system energy may be high enough to break down the crosslinks and thin the fluid, but at the lower shear rates experienced in the fracture, the crosslinks reform and viscosity should increase, thereby improving proppant transport when present.

When using proppant material, after a specified amount of proppant is deposited into the formation, the wellbore may be shut in by closing a valve at the surface for a period of time sufficient to permit stabilization of the subterranean formation. One should note that contact with formation fluids, such as oils and brines, may negatively affect the micellar bonds of the fracturing fluid thereby reducing the viscosity and allowing it to be recovered from the subterranean formation. Chemical breakers may also be included if desired to degrade the polymer backbone thereby lowering the viscosity of the fracturing fluid. Suitable chemical breakers may include, but are not limited to, oxidizing agents such as sodium peroxydisulfate, t-butyl hydroperoxide, sodium chlorite, and sodium bromate. If used, they should be used in an amount of from about 0.01% to about 2% by weight. Following the reduction in viscosity, the fracturing fluid flows out of the fracture leaving the proppant material, when present, in the fractures. Since conventional polyvalent metal ion crosslinking agents are not required, filter cake on the walls of the well bore can be more easily removed, providing for improved well performance.

A viscosity-enhancing agent may optionally be added to the fracturing fluid. The viscosity-enhancing agent is capable of enhancing the formation of micellar bonds between hydrophobic groups on the polymer and hydrophobic groups on the same or adjacent polymer molecules. Suitable viscosity-enhancing agents include, but are not limited to, fatty alcohols, ethoxylated fatty alcohols and amine oxides having hydrophobic chain lengths of 6 to 22 carbon atoms, and mixtures thereof. Preferably, the viscosity-enhancing agent is present in the fracturing fluid in an amount in the range of from about 0.05% to about 1.0% thereof, and more preferably from about 0.1% to about 0.6%.

In some embodiments, the fracturing fluids of the present invention may be foamed. An advantage of foamed fracturing fluids is that they are thought to cause less damage to the formation than non-foamed fracturing fluids. Foamed fluids generally contain less liquid and have less tendency to leak into the matrix of the rock formation. Also, the sudden expansion of gas in the foams when the pressure in the well is relieved is thought to promote the flow of the fracturing fluid back out of the formation and into the well after the fracturing operation is complete.

In some embodiments, the current invention provides methods for fracturing a subterranean formation penetrated by a well bore by utilizing a foamed fracturing fluid. The foamed fracturing fluid is prepared comprising water, a charged polymer in an amount in the range of from about 2000 to about 20000 ppm of the treating fluid, a surfactant having a charge that is opposite of the charged polymer, an effective amount of foaming agent, and sufficient gas to form a foam. The surfactant is capable of forming micellar bonds between hydrophobic groups on the polymer and hydrophobic groups on the same or adjacent polymer molecules to form crosslinks. The surfactant may also function as the foaming agent; thus, the foaming agent need not be a separate component from the surfactant. The fracturing fluid may optionally contain proppant and a viscosity-enhancing agent. The foamed fracturing fluid has a viscosity suitable for fracturing the formation according to foamed fracturing methods known to those skilled in the art, and is introduced into the subterranean formation through the well bore under conditions effective to create or enhance at least one fracture therein.

Examples of gases suitable for foaming the fracturing fluid of this invention are air, nitrogen, carbon dioxide and mixtures thereof. The gas may be present in the fracturing fluid in an amount in the range of from about 10% to about 95% by volume of liquid, preferably from about 20% to about 90%, and most preferably from about 20% to about 80% by volume.

Examples of foaming agents that may be utilized in the present invention include cationic surfactants such as quaternary compounds or protonated amines with hydrophobic groups having a chain length of from about 6 to 22 carbon atoms. Such compounds include but are not limited to trimethylcocoammonium chloride, trimethyltallowammonium chloride, dimethyldicocoammonium chloride, bis(2-hydroxyethyl)tallowamine, bis(2-hydroxyethyl)erucylamine, bis(2-hydroxyethyl)cocoamine, cetylpyridinium chloride, and mixtures thereof. Other suitable foaming agents include, but are not limited to, anionic surfactants having a chain length of from about 6 to about 22 carbon atoms such as alpha olefin sulfonate, alkylether sulfates, alkyl phosphonates, alkane sulfonates, fatty acid salts, and arylsulfonic acid salts. Preferred foaming agents include trimethyltallowammonium chloride and alphaolefin sulfonate having a chain length of 14 to 16 carbon atoms. The surfactant used in the present invention for forming hydrophobically modified polymer may also function as the foaming agent. Preferably, the foaming agent is present in the foamed fracturing fluid in an amount in the range of from about 0.1% to about 2% by weight thereof. If the foaming agent is the same as the surfactant used in the fracturing fluid, then this quantity should be used in addition to the surfactant required for hydrophobically modified polymer formation.

In some embodiments, the treating fluids of this invention comprise water, a charged polymer in an amount in the range of from about 2000 to about 20000 ppm of the treating fluid, and a surfactant having a charge that is opposite to that of the charged polymer and capable of forming micellar bonds between hydrophobic groups on the polymer and hydrophobic groups on the same or adjacent polymer molecules to form crosslinks. A viscosity-enhancing agent may be added to the treating fluid to increase the viscosity of the fluid. As will be understood by those skilled in the art, a variety of conventional additives can be included in the treating fluid such as proppant particulates, gel stabilizers, gel breakers, clay stabilizers, bactericides, fluid loss additives and the like which do not adversely react with the hydrophobically modified polymer.

A preferred method of this invention comprises the steps of: (a) providing a treating fluid comprising water, a charged polymer in an amount in the range of from about 2000 to about 20000 ppm, and a surfactant having a charge that is opposite to that of the charged polymer, the surfactant being capable of forming a micellar bond between a hydrophobic group on the polymer and a hydrophobic group on the same or an adjacent polymer molecule to form a crosslink; and (b) injecting the treating fluid into a well bore to treat the subterranean formation.

A preferred composition of this invention is a viscosified treating fluid that comprises: water; a charged polymer; a surfactant having a charge that is opposite to that of the charged polymer in an amount in the range of from about 2000 to about 20000 ppm of the treating fluid; and at least one micellar association of the surfactant with the charged polymer.

To facilitate a better understanding of the present invention, the following examples of certain aspects of some embodiments are given. In no way should the following examples be read to limit, or define, the scope of the invention.

### EXAMPLES

### Example 1

An aqueous solution of carboxymethylhydroxypropyl guar (CMHPG) was prepared by adding 4.8 g CMHPG to 1 L of water in a blender jar. The polymer was allowed to hydrate for fifteen minutes at pH 7. A 100 mL aliquot of the hydrated CMHPG fluid was placed into another blender jar and the cationic surfactant trimethyl cocoammonium chloride was added to the CMHPG fluid in quantities ranging from 0.02 mL to 0.5 mL. The viscosity of the mixture was measured using a Fann 35 viscometer at a shear rate of 511 sec⁻¹ at different concentrations of trimethyl cocoammonium chloride. Table 1 shows the increase in viscosity with increasing trimethyl cocoammonium chloride concentration.

TABLE 1
Effect of Anionic Polymer on Viscosity

| Trimethylcocoammonium Chloride, % | Viscosity @ 511 s⁻¹, cP |
|---|---|
| 0.0 | 32.7 |
| 0.1 | 46.3 |
| 0.2 | 57.5 |
| 0.3 | 42.5 |

Increasing the blender speed from slow to moderate caused the mixture to foam due to entrained air. An increase in the volume of the fluid from 100 mL to 360 mL was observed due to stirring. The foam was transferred to a 1 L graduated cylinder. A time of forty-four minutes was required to drain one-half of the liquid from the foam, indicating substantial stability of the foam.

### Example 2

A 350 mL blender jar was charged with 300 mL of Duncan, OK tap water. While shearing, 3.0 g of quaternized hydroxyethylcellulose ethoxylate, referred to generally as Polyquaternium-10 and available commercially from Aldrich Chemical Co. of Milwaukee, Wis., was added to make a 1% solution of the cationic polymer. Sodium dodecyl sulfate (SDS), an anionic surfactant, was added in 0.03 g (0.01%) increments. The viscosity was measured with a Chandler model 35 viscometer at 100 rpm (170 sec⁻¹ shear rate) before any surfactant was added, and after each surfactant addition. This example demonstrated the increase in viscosity due to the addition of anionic surfactant to a solution of positively charged polymer. The change in viscosity with the addition of anionic surfactant is shown in Table 2.

TABLE 2
Anionic Surfactant Addition to Positively
Charged Polymer and Effect on Viscosity

| | Apparent viscosity, |
|---|---|
| Sodium laurylsulfate, % | cP |
| 0 | 36 |
| 0.01 | 36 |
| 0.02 | 39 |
| 0.03 | 48 |
| 0.04 | 62 |
| 0.05 | 84 |
| 0.06 | 120 |
| 0.07 | 156 |
| 0.08 | 228 |
| 0.09 | 304 |
| 0.1 | 373 |
| 0.11 | 439 |
| 0.12 | 523 |
| 0.13 | 589 |
| 0.14 | 628 |
| 0.15 | 667 |
| 0.16 | 643 |

### Example 3

The apparent viscosity of a 1% solution of Polyquatemium-10, described above, was measured using a Fann 35 viscometer at 100 rpm. The viscosity was measured again after the addition of 0.06% sodium lauryl sulfate anionic surfactant. As shown in Table 3, the surfactant significantly increased the solution viscosity. Addition of a viscosity-enhancing agent, alpha-sulfo fatty acid monomethyl ester sodium salt, resulted in another dramatic increase in viscosity.

TABLE 3
Effect of Ionic Viscosity Enhancing Agent

| | Alpha-sulfo fatty acid | Apparent |
|---|---|---|
| % Sodium lauryl sulfate | monomethyl ester, sodium salt | viscosity, cP |
| 0 | 0 | 33 |
| 0.06% | 0 | 159 |
| 0.06% | 0.12% | 711 |

### Example 4

The experiment described in Example 3 was repeated with several modifications. This time the amount of sodium lauryl sulfate was increased to 0.1% and dodecyl alcohol was tested as a non-ionic viscosity-enhancing agent. The viscosity increase due to this small amount of dodecyl alcohol was not dramatic. However, as shown in Table 4, it did enhance the viscosity apparently without electrostatically bonding (since it is nonionic) to the Polyquaternium-10.

TABLE 4
Effect of Nonionic Viscosity Enhancing Agent

| Sodium lauryl sulfate | Dodecyl alcohol | Apparent viscosity, cP |
|---|---|---|
| 0 | 0 | 36 |
| 0.1% | 0 | 333 |
| 0.1% | 0.02% | 366 |

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, and set forth every range encompassed within the broader range of values. Additionally, in some instances, the fluids are described in terms of the original components rather than as a mixture that results from those components; in other instances, the fluids are described in terms of the resulting components. The fluids should be read consistently with the point in time in which they are intended to be described. Also, the terms in the claims have their plain, ordinary meaning unless otherwise explicitly and clearly defined by the patentee.

What is claim is:

1. A method comprising:
providing a treating fluid comprising water, a charged polymer in an amount in the range of from about 2000 to about 20000 ppm, and a surfactant having a charge that is opposite to that of the charged polymer, the surfactant being capable of forming a micellar bond between a hydrophobic group on the polymer and a hydrophobic group on the same or an adjacent polymer molecule to form a crosslink; and
placing the treating fluid into a well bore.

2. The method of claim 1 wherein the charged polymer is an anionic polymer selected from the group consisting of carboxymethyl guar, carboxymethylhydroxypropyl guar, carboxymethylhydroxyethyl cellulose, polyacrylic acid, polyacrylate copolymers, 2-acrylamido-2-methylpropanesulfonic acid and salts, and combinations and mixtures thereof.

3. The method of claim 1 wherein the charged polymer is a cationic polymer selected from the group consisting of cationic polyacrylamide copolymers, cationic guar, cationic cellulose derivatives, cationic polysaccharide derivatives, choline methacrylate salts, and combinations and mixtures thereof.

4. The method of claim 1 wherein the treating fluid further comprises a viscosity-enhancing agent capable of enhancing the formation of a micellar bond between a hydrophobic group on the polymer and a hydrophobic group on the same or adjacent polymer molecule.

5. The method of claim 1 wherein the treating fluid further comprises a borate crosslinking agent selected from the group consisting of alkali metal borates, borax, boric acid, borate esters, and compounds that are capable of releasing borate ions in aqueous solutions.

6. A method comprising:
providing a viscosified treating fluid comprising:
water;
a charged polymer in an amount in the range of from about 2000 to about 20000 ppm;
a surfactant having a charge that is opposite to that of the charged polymer; and
at least one micellar association between the surfactant and the charged polymer; and
placing the viscosified treating fluid into a well bore.

7. The method of claim 6 wherein the charged polymer is an anionic polymer selected from the group consisting of carboxymethyl guar, carboxymethylhydroxypropyl guar, carboxymethylhydroxyethyl cellulose, polyacrylic acid, polyacrylate copolymers, 2-acrylamido-2-methylpropanesulfonic acid and salts, and combinations and mixtures thereof.

8. The method of claim 6 wherein the charged polymer is a cationic polymer selected from the group consisting of cationic polyacrylamide copolymers, cationic guar, cationic cellulose derivatives, cationic polysaccharide derivatives, choline methacrylate salts, and combinations and mixtures thereof.

9. The method of claim 6 wherein the viscosified treating fluid further comprises a viscosity-enhancing agent capable of enhancing the formation of a micellar bond between a hydrophobic group on the polymer and a hydrophobic group on the same or adjacent polymer molecule.

10. The method of claim 6 wherein the viscosified treating fluid further comprises a proppant material.

11. The method of claim 6 wherein the viscosified treating fluid further comprises a borate crosslinking agent selected from the group consisting of alkali metal borates, borax, boric acid, borate esters, and compounds that are capable of releasing borate ions in aqueous solutions.

12. The method of claim 6 further wherein the viscosified treating fluid further comprises an effective amount of a foaming agent and sufficient gas to form a foam.

13. A viscosified treating fluid comprising:
water;
a charged polymer;
a surfactant having a charge that is opposite to that of the charged polymer in an amount in the range of from about 2000 to about 20000 ppm of the treating fluid; and
at least one micellar association between the surfactant and the charged polymer.

14. The composition of claim 13 wherein the charged polymer is an anionic polymer selected from the group consisting of carboxymethyl guar, carboxymethylhydroxypropyl guar, carboxymethylhydroxyethyl cellulose, polyacrylic acid, polyacrylate copolymers, 2-acrylamido-2-methylpropanesulfonic acid and salts, and combinations and mixtures thereof.

15. The composition of claim 13 wherein the charged polymer is a cationic polymer selected from the group consisting of cationic polyacrylamide, cationic guar, cationic cellulose derivatives, cationic polysaccharide derivatives, choline methacrylate salts, and combinations and mixtures thereof.

16. The composition of claim 13 wherein the charged polymer is cationic and the surfactant is an anionic surfactant selected from the group consisting of alpha olefin sulfonate, alkylether sulfates, alkyl phosphonates, alkane sulfonates, fatty acid salts, and arylsulfonic acid salts, and combinations and mixtures thereof.

17. The composition of claim 13 wherein the charged polymer is anionic and the surfactant is a cationic surfactant selected from the group consisting of trimethylcocoammonium chloride, trimethyltallowammonium chloride, dimethyldicocoammonium chloride, bis(2-hydroxyethyl)tallowamine, bis(2-hydroxyethyl)erucylamine, bis(2-hydroxyethyl)cocoamine, cetylpyridinium chloride, and combinations and mixtures thereof.

18. The composition of claim 13 further comprising a viscosity-enhancing agent capable of enhancing the formation of a micellar bond between a hydrophobic group on the polymer and a hydrophobic group on the same or adjacent polymer molecule.

19. The composition of claim 13 further comprising a proppant.

20. The composition of claim 13 further comprising an effective amount of a foaming agent and sufficient gas to form a foam.

21. The composition of claim 13 wherein the viscosified treating fluid further comprises a borate crosslinking agent selected from the group consisting of alkali metal borates, borax, boric acid, borate esters, and compounds that are capable of releasing borate ions in aqueous solutions.
